(19) United States
(12) Patent Application Publication
(10) Pub. No.: US 2012/0000743 A1
(43) Pub. Date: Jan. 5, 2012

(54) HILL-HOLDER ASSEMBLY FOR A TRANSMISSION

(75) Inventors: Scott H. Wittkopp, Ypsilanti, MI (US); Hamid Vahabzadeh, Oakland, MI (US); James B. Borgerson, Clarkston, MI (US); Bret M. Olson, Whitelake, MI (US); James M. Hart, Belleville, MI (US)

(73) Assignee: GM GLOBAL TECHNOLOGY OPERATIONS, INC., Detroit, MI (US)

(21) Appl. No.: 12/830,097

(22) Filed: Jul. 2, 2010

(51) Int. Cl. F16D 48/00

(52) U.S. Cl. 192/219.1

(57) ABSTRACT

A device operable in a transmission for substantially preventing vehicular rollback on an incline includes a shaft, a gear, a one-way clutch, and a pawl member. The gear is selectively connected for common rotation with the shaft. The gear is rotatable in a first rotary direction and a second rotary direction. The one-way clutch has an inner race and an outer race, where the inner race is connected to the gear and the outer race has an outer surface having a plurality of engaging teeth. The pawl member has a first end and a second end, where the first end is pivotly mounted to a transmission housing. The second end of the pawl has a first angled portion configured to releasably engage at least one of the plurality of engaging teeth of the outer race as the outer race rotates in the second rotary direction.

### FIELD

The present disclosure relates to a transmission, and more particularly to a transmission including a hill-holder assembly operable for preventing vehicular rollback on an incline including a pawl member.

### BACKGROUND

The statements in this section merely provide background information related to the present disclosure and may or may not constitute prior art.

Automatic transmissions typically include a torque converter that generates creep torque. The creep torque created by an automatic transmission is usually sufficient to prevent a vehicle from rolling backwards if the vehicle is idling on a level surface or on a slight grade. However, manual and dual clutch transmissions (DCTs) usually have less creep torque than automatic transmissions. As a result, these transmissions may employ a hill-holder mechanism in an effort to keep the vehicle from rolling backwards on an incline. In one approach, an electronic braking system could be used as the hill-holder mechanism, however the electronic braking system is costly to implement in a vehicle. Therefore, other less costly approaches to implementing a hill-holder mechanism are desired.

One less costly approach when compared to an electronic braking system is a one-way clutch (OWC). However, several issues exist that make implementing a one-way clutch not feasible in some situations. For example, if a selectable one-way clutch is used for the park, hill-hold drive (where the hill-hold feature is available), and reverse gear positions, the self-locking elements in the one-way clutch do not allow for the transmission to be shifted from the hill-hold drive into the reverse gear position. Therefore, there exists a need in the art for a hill-hold mechanism that is cost effective and functional.

### SUMMARY

The present invention provides a device operable in a transmission of a vehicle for substantially preventing vehicular rollback on an incline, including a shaft, a gear, a one-way clutch and a pawl member. The shaft is rotatably supported in a transmission housing. The gear is selectively connected for common rotation with the shaft and is rotatable in a first rotary direction and a second rotary direction. The first rotary direction represents a forward gear ratio of the transmission and the second rotary direction represents a reverse gear ratio of the transmission. The one-way clutch has an inner race and an outer race. The inner race is connected to the gear and the outer race has an outer surface having a plurality of engaging teeth. The one-way clutch is configured to allow the inner race to rotate relative to the outer race when the gear rotates in the first rotary direction, and is configured to prevent the inner race from rotating relative to the outer race as the gear rotates in the second rotary direction. The pawl has a first end and a second end where the first end is pivotly mounted to the transmission housing. The second end of the pawl has a first angled portion configured to releasably engage at least one of the plurality of engaging teeth of the outer race as the outer race rotates in the second rotary direction, where the first angled portion remains engaged with one of the plurality of engaging teeth under a predefined load. The pawl includes a second angled portion configured to release from the plurality of engaging teeth of the outer race as the outer race rotates in the first direction.

In an embodiment of the present invention, the first angled portion is angled at about twelve degrees when measured from a first side of the pawl.

In another embodiment of the present invention, the second angled portion is angled at about forty-five degrees when measured from a second side of the pawl.

In yet another embodiment of the present invention, the first angle and the second angle taper inwardly towards a center portion of the second end of the pawl.

In an embodiment of the present invention, the predefined load is the load exerted by the outer race on the pawl when the vehicle is located on an incline.

In another embodiment of the present invention, the pawl is actuated by a park pawl mechanism to selectively engage with the plurality of engaging teeth of the outer race.

In yet another embodiment of the present invention, the one-way clutch is a sprag-clutch type assembly having a plurality of sprags that are located between the inner race and the outer race.

In an embodiment of the present invention, the transmission is a dual-clutch type transmission.

In an embodiment of the present invention, the inner race is connected to the first gear by a splined engagement.

In an embodiment of the present invention, the gear is selectively connected to the shaft to achieve a first gear ratio.

A device operable in a transmission for substantially preventing vehicular rollback on an incline includes a shaft, a gear, a clutch, a pin, a biasing member, and a synchronizer assembly. The shaft is rotatably supported in a transmission housing. The gear is selectively connected for common rotation with the shaft. The gear is rotatable in a first rotary direction and a second rotary direction, where the first rotary direction represents a forward gear ratio of the transmission and the second rotary direction represents a reverse gear ratio of the transmission. The clutch member has a first end face, a second end face, and a disk. The disk is coupled to the gear and has an outer surface having a plurality of engaging teeth. The pin member has a first end and a second end, where the first end is coupled to the transmission housing. The second end of the pin fixedly engages with one of the plurality of engaging teeth of the outer surface of the clutch in an engaged position and disengages with the corresponding one of the plurality of engaging teeth in a disengaged position. The biasing member is in contact with the first end face of the clutch. The synchronizer assembly includes a synchronizer fork and an apply ring, where the apply ring is axially moved by the synchronizer fork. The apply ring contacts the second end face of the clutch. The apply ring is actuated in a first direction towards the pin to axially move the clutch into the engaged position when the forward gear ratio is selected. The biasing member exerts a biasing force on the clutch in a second direction away from the pin to axially move the clutch into the disengaged position when the reverse gear ratio is selected.

In an embodiment of the present invention, the pin includes an outer profile that is shaped to fixedly engage with the teeth of the disk as the disk rotates in the second direction.

In another embodiment of the present invention, the outer profile of the pin is generally conical.

In yet another embodiment of the present invention, the teeth of the disk includes an engagement surface that generally corresponds to the outer profile of the pin.

In an embodiment of the present invention, the apply finger receives a collar, and wherein the collar is connected to the actuating member.

In another embodiment of the present invention, the plurality of engaging teeth has a saw toothed profile.

In yet another embodiment of the present invention, the transmission is a dual-clutch type transmission.

In an embodiment of the present invention, the disk is coupled to the first gear by a splined engagement.

In another embodiment of the present invention, the pin is coupled to the transmission housing by a bearing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exemplary schematic illustration of a multiple speed dual clutch transmission employing a hill-holder assembly;

FIG. 2A is a cross-sectioned view of the hill-holder assembly illustrated in FIG. 1 including a one-way clutch and a hill-hold pawl;

FIG. 2B is an enlarged view of the one-way clutch illustrated in FIG. 2A;

FIG. 2C is an enlarged view of the hill-hold pawl illustrated in FIG. 2A;

FIG. 3A is an exemplary schematic illustration of a multiple speed dual clutch transmission employing an alternative embodiment of a hill-holder assembly;

FIG. 3B is a side view of an alternative embodiment of a hill-holder assembly in a first disengaged position;

FIG. 3C is a side view of the hill-holder assembly illustrated in FIG. 3A in a second engaged position;

FIG. 3D is a cross-sectioned view of the hill-holder assembly including a hill-hold pin illustrated in FIG. 3A; and

FIG. 3E is an enlarged view of the hill-hold pin shown in FIG. 3C.

### DETAILED DESCRIPTION

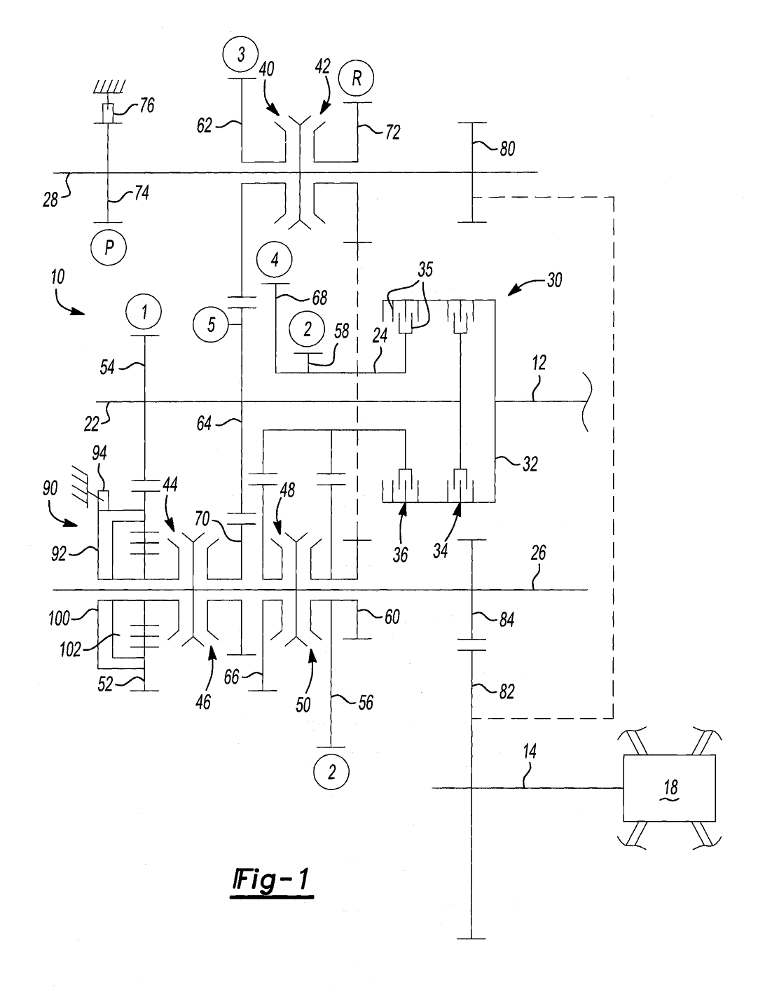

The following description is merely exemplary in nature and is not intended to limit the present disclosure, application, or uses. With reference to FIG. 1, a schematic illustration of an exemplary multi-speed transmission 10 employed in a vehicle (not shown) is indicated by reference number 10. The transmission 10 includes an input shaft or member 12 and an output shaft or member 14. In the embodiment as shown, the input shaft 12 is the output shaft of an engine (not shown), and the output shaft 14 is continuously connected to a final drive unit 18. The transmission 10 has a countershaft gearing arrangement having a first interconnecting member 22, a second interconnecting member 24 that is a sleeve concentric with the first interconnecting member 22, a first countershaft 26 and a second countershaft 28. The countershafts 26 and 28 are both spaced apart from and parallel with the interconnecting shafts 22, 24 and are rotateably supported in a transmission housing (not shown). A dual clutch 30 is connected between the input shaft 12 and the first and second interconnecting shafts 22 and 24. The dual clutch 30 includes a clutch housing 32 connected for common rotation with input shaft 12 as well as first and second clutch elements or hubs 34 and 36 that have friction plates 35 mounted thereon that interact to form a friction clutch. The clutch element 34 is connected for common rotation with the first interconnecting shaft 22 and the clutch element 36 is connected for common rotation with the second interconnecting shaft 24. It should be noted that while FIG. 1 illustrates the transmission 10 as a dual clutch type transmission, other types of transmissions such as a manual transmission may be used as well.

The countershaft gearing arrangement also includes gear sets 1, 2, 3, 4, and 5 for creating a plurality of forward gear ratios as well as a gear set R for creating a reverse gear ratio. The transmission 10 also includes a plurality of selectively engageable synchronizers 40, 42, 44, 46, 48 and 50. In the embodiment as shown, the transmission 10 transmits torque in at least five forward ratios as well as one reverse torque ratio, however it is understood that fewer or more gear sets may be employed in the transmission 10 as well. Each of the forward gear ratios and the reverse gear ratio are attained by engagement of one of the clutch elements 34 and 36 and one or more of the synchronizers 40, 42, 44, 46, 48 and 50.

In the embodiment as illustrated in FIG. 1, the gear set 1 is employed to establish a first forward gear ratio. The gear set 1 includes co-planar intermeshing gears 52 and 54, where the gear 52 is selectively connected for common rotation with the first countershaft 26 and the gear 54 is connected for common rotation with first interconnecting shaft 22. The gear set 2 is employed to establish a second forward ratio and includes co-planar intermeshing gears 56 and 58, where the gear 56 is selectively connected for common rotation with the first countershaft 26 and the gear 58 is connected for common rotation with second interconnecting shaft 24. The gear set 2 also includes a transfer gear portion 60. The gear set 3 is employed to establish a third forward ratio and includes co-planar intermeshing gears 62 and 64, where the gear 62 is selectively connected for common rotation with the second countershaft 28 and the gear 64 is connected for common rotation with first interconnecting shaft 22. The gear set 4 is employed to establish a fourth forward ratio includes co-planar intermeshing gears 66 and 68, where the gear 66 is selectively connected for common rotation with the first countershaft 26 and the gear 68 is connected for common rotation with second interconnecting shaft 24. The gear set 5 is employed to establish a fifth forward ratio and includes co-planar intermeshing gears 64 and 70, where the gear 70 is selectively connected for common rotation with the first countershaft 26 and the gear 64 is connected for common rotation with first interconnecting shaft 22. A gear 72 is employed to establish a reverse gear ratio, where the gear 72 is selectively connected to the second countershaft 28.

A gear 74 is employed as a parking gear that is connected with the second countershaft 28. A parking pawl member 76 engages with the gear 74 to substantially prevent rotation of the countershaft 28 when the park function of the transmission 10 is selected. Specifically, when the transmission 10 is in the park position, the parking pawl 76 engages with the gear 74, thereby substantially preventing the rotation of the second countershaft 28. A countershaft transfer gear 80 located on the second countershaft 28 meshes with an output transfer gear 82 located on the output shaft 14 to prevent rotation of the output shaft 14.

To establish the reverse gear ratio, the clutch element 36 and the synchronizer 42 are engaged. By this engagement, the clutch element 36 of the dual clutch 30 transfers torque from the input shaft 12 to the through the clutch housing 32 and to the second interconnecting shaft 24. Torque is transferred from the second interconnecting shaft 24 through gear 58 to gear 56. The transfer gear portion 60 meshes with the gear 72 of the reverse gear ratio. Upon engagement of the synchronizer 42, torque is transferred from the gear 72 to the second countershaft 28. The second countershaft 28 transfers torque to the countershaft transfer gear 80. The countershaft transfer gear 80 transfers torque to the output transfer gear 82 which transfers torque to the output shaft 14. The output shaft 14 transfers torque to the final drive unit 18.

To establish the first gear ratio, the clutch element 34 and the synchronizer 44 are engaged. By this engagement, the clutch element 34 of the dual clutch 30 transfers torque from the input shaft 12 to the through the clutch housing 32 and to the first interconnecting shaft 22. Torque is transferred from the first interconnecting shaft 22 through gear 54 to gear 52. Upon engagement of the synchronizer 44, torque is transferred from the gear 52 to the first countershaft 26. The first countershaft 26 transfers torque to a countershaft transfer gear 84. The countershaft transfer gear 84 transfers torque to the output transfer gear 82 which transfers torque to the output shaft 14. The output shaft 14 transfers torque to the final drive unit 18.

To establish the second gear ratio, the clutch element 36 and the synchronizer 50 are engaged. By this engagement, the clutch element 36 of the dual clutch 30 transfers torque from the input shaft 12 to the through the clutch housing 32 and to the second interconnecting shaft 24. Torque is transferred from the second interconnecting shaft 24 through gear 58 to the gear 56. Upon engagement of the synchronizer 50, torque is transferred from the gear 60 to the first countershaft 26. The first countershaft 26 transfers torque to a countershaft transfer gear 84. The countershaft transfer gear 84 transfers torque to the output transfer gear 82 which transfers torque to the output shaft 14. The output shaft 14 transfers torque to the final drive unit 18.

To establish the third gear ratio, the clutch element 34 and the synchronizer 40 are engaged. By this engagement, the clutch element 34 of the dual clutch 30 transfers torque from the input shaft 12 to the through the clutch housing 32 and to the first interconnecting shaft 22. Torque is transferred from the first interconnecting shaft 22 through gear 64 to gear 62. Upon engagement of the synchronizer 40, torque is transferred from the gear 62 to the second countershaft 28. The second countershaft 28 transfers torque to a countershaft transfer gear 80. The countershaft transfer gear 80 transfers torque to the output transfer gear 82 which transfers torque to the output shaft 14. The output shaft 14 transfers torque to the final drive unit 18.

To establish the fourth gear ratio, the clutch element 36 and the synchronizer 48 are engaged. By this engagement, the clutch element 36 of the dual clutch 30 transfers torque from the input shaft 12 to the through the clutch housing 32 and to the second interconnecting shaft 24. Torque is transferred from the second interconnecting shaft 24 through gear 68 to gear 66. Upon engagement of the synchronizer 48, torque is transferred from the gear 66 to the first countershaft 26. The first countershaft 26 transfers torque to a countershaft transfer gear 84. The countershaft transfer gear 84 transfers torque to the output transfer gear 82 which transfers torque to the output shaft 14. The output shaft 14 transfers torque to the final drive unit 18.

To establish the fifth gear ratio, the clutch element 34 and the synchronizer 46 are engaged. By this engagement, the clutch element 34 of the dual clutch 30 transfers torque from the input shaft 12 to the through the clutch housing 32 and to the first interconnecting shaft 22. Torque is transferred from the first interconnecting shaft 22 through gear 64 to gear 70. Upon engagement of the synchronizer 46, torque is transferred from the gear 70 to the first countershaft 26. The first countershaft 26 transfers torque to a countershaft transfer gear 84. The countershaft transfer gear 84 transfers torque to the output transfer gear 82 which transfers torque to the output shaft 14. The output shaft 14 transfers torque to the final drive unit 18.

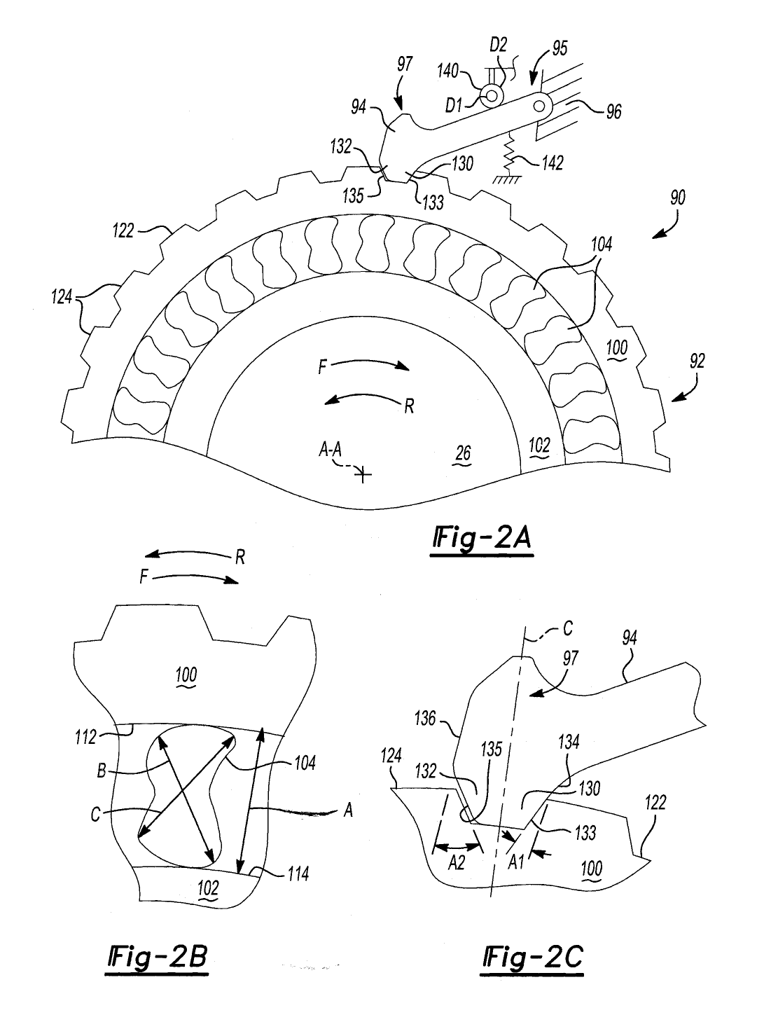

A hill-hold assembly 90 is connected to the gear 52, and is operable to substantially prevent the vehicle from rolling backwards on an incline when the transmission 10 is operating in the first gear ratio. The hill-holder assembly 90 includes a one-way clutch 92 and a hill-hold pawl 94 that is releaseably engaged with the one-way clutch 92. FIG. 2A is an illustration of the hill-holder assembly 90 including the one-way clutch 92 and the hill-hold pawl 94. The hill-hold pawl 94 has a first end 95 and a second end 97, where the first end 95 is pivotly mounted to a transmission wall 96. The one-way clutch 92 has an outer race 100, an inner race 102, and a plurality of sprags 104. In the embodiment as shown in FIG. 2A, the one-way clutch 92 is a sprag clutch type assembly, however it is understood that other types of one-way clutches may be used as well. For example, in an alternative embodiment the one-way clutch could be a rocker type clutch. In the embodiment as shown, the inner race 102 is connected to the gear 52 by a splined connection (FIG. 1), however it is understood that other approaches may be used as well to connect the inner race 102 to the gear 52.

The inner race 102 is rotatable about an axis A-A by the gear 52 (FIG. 1) and is rotatable in a first rotary direction F and a second rotary direction R. The first rotary direction F represents a forward gear ratio of the transmission 10 and the rotary direction R represents a reverse gear ratio. The one-way clutch 92 is employed to selectively allow for the inner race 102 to transmit torque to the outer race 100. When the gear 52 and the inner race 100 are rotating in the first rotary direction F, each sprag 104 is positioned to allow relative rotation between the inner race 102 and the outer race 100, and the inner race 102 does not transmit torque through the plurality of sprags 104 to the outer race 100. When the gear 52 and the inner race 102 are rotating in the second rotary direction R, the inner race 102 and the outer race 100 are fixed for common rotation, and the inner race 102 transmits torque through the plurality of sprags 104 to the outer race 100.

Continuing to refer to FIG. 2A, each sprag 104 is dimensioned such that when the inner race 102 rotates in the first rotary direction F, the sprags 104 are free from the races to allow relative rotation between the inner and outer races 100 and 102. When the inner race 102 rotates in the second rotary direction R, the sprags 104 are wedged tightly between the inner race 102 and the outer race 100 to limit relative rotation between the inner and outer races 100 and 102. Specifically, turning to FIG. 2B, a first distance A is measured between the innermost surface 112 of the outer race 100 and the outermost surface 114 of the inner race 102. The sprag 104 includes two different diagonally spaced dimensions, distance B and distance C. Distance B is greater than distance A and distance C is less than distance A. Thus, when the inner race 102 rotates in the first rotary direction F, each of the sprags 104 pivot such that distance C is wedged between the races 100 and 102, which allows for free rotation. When the inner race 102 rotates in the second rotary direction R, each of the sprags 104 pivot such that distance B is wedged between the races 100 and 102, which causes the sprags 104 to wedge between the races 100 and 102 and stops relative rotation.

Turning back to FIG. 2A, the outer race 100 has an outer surface 122 including a plurality of outer teeth 124. The outer teeth 124 of the outer race 100 are configured to selectively engage with the hill-hold pawl 94. Specifically, the second end 97 of the hill-hold pawl 94 includes a first angled portion 130 and a second angled portion 132. The first angled portion 130 and the second angled portion 132 are each located along an engagement surface of the hill-hold pawl 94 and are configured to selectively engage with the outer teeth 124 of the outer race 100 depending on the rotational direction of the outer race 100. When the inner race 102 rotates in the first rotary direction F, movement of the outer teeth 124 in the first rotary direction F causes the outer teeth 124 to release from the hill-hold pawl 94 due to the steep angle on the second angled portion 132. When the inner race 102 rotates in the second rotary direction R, movement of the outer race 100 in the second rotary direction R causes the outer teeth 124 to engage with the first angled portion 130 of the hill-hold pawl 94. The first angled portion 130 of the hill-hold pawl 94 releaseably engages with the outer teeth 124 such that the hill-hold pawl 94 and the outer race 100 are in engagement with one another when a predefined load is exerted on the hill-hold pawl 94 through the outer race 100.

FIG. 2C is an enlarged view of the second end 97 of the hill-hold pawl 94 engaged with the outer teeth 124 of the outer race 100. In the embodiment as illustrated, the first angled portion 130 of the hill-hold pawl 94 has a first engagement surface 133 that selectively engages with the outer surface 122 of the outer teeth 124 of the outer race 100. In the embodiment as illustrated, the first engagement surface 133 is located at a first angle A1 of approximately twelve degrees when measured from a first side 134 of the hill-hold pawl 94. The second angled portion 132 of the hill-hold pawl 94 has a second engagement surface 135 that also selectively engages with the outer surface 122 of the outer teeth 122 of the outer teeth 124 of the outer race 100. In the embodiment as illustrated, the second engagement surface 135 is located at a second angle A2 of approximately forty-five degrees when measured from a second side 136 of the hill-hold pawl 94. Both the first and second angles A1 and A2 taper inwardly towards a center portion C-C of the hill-hold pawl 94. Although FIG. 2C illustrates the first angle A1 having a dimension of about twelve degrees and the second angle A2 having a dimension of about forty-five degrees, those skilled in the art will appreciate that other dimensions may be used as well to operate the hill-hold pawl 94.

Referring to FIG. 2A, it should be noted that the hill-hold pawl 94 is in selective engagement with the outer teeth 124 and is actuated by a standard parking pawl mechanism such as, for example, a rod 140 that is driven by an actuator (not shown) and a return spring 142. The rod 140 selectively actuates the hill-hold pawl 94 depending on the gear position of the transmission 10. The rod 140 is a conventional elongated parking rod having a first diameter D1 and a second diameter D2, where the second diameter D2 is greater than the first diameter D1. The rod 140 can be actuated in a direction generally parallel to the axis A-A of the inner race 102 to selectively engage the hill-hold pawl 94 with the outer teeth 124 of the outer race 100. Specifically, if the first diameter D1 contacts the hill-hold pawl 94, the hill-hold pawl 94 will disengage with the outer teeth 124. If the second diameter D2 contacts the hill-hold pawl 94, then the hill-hold pawl 94 will engage with the outer teeth 124 of the outer race 100.

Referring to FIGS. 1, 2A and 2C, when the transmission 10 (FIG. 1) is in the first gear ratio, the gear 52 rotates the inner race 102 of the one-way clutch 92 in the first rotary direction F. The inner race 102 rotates in the first rotary direction F relative to the outer race 100 such that the inner race 102 does not transfer torque to the outer race 100. The outer race 100 may freely rotate in the first rotary direction F, as the second angle A2 is dimensioned such that the second engagement surface 135 of the hill hold pawl 94 will release from the outer teeth 124 of the outer race 100. Specifically, the torque created as the one-way clutch 92 rotates will cause the hill-hold pawl 94 to disengage with the outer race 100, as the second angle A2 is relatively steep when compared to the dimensions of the first angle A1.

If the vehicle is on an incline in the first gear ratio, the hill-holder assembly 90 is employed to substantially prevent the vehicle from rolling backwards on an incline. Specifically, gravity can cause the wheels of the vehicle (not shown) to roll backwards on an incline, thus causing the output shaft 14 (FIG. 1) to also rotate in a backwards rotational direction. The transfer gear 82 of the output shaft 14 meshes with the transfer gear 84 of the first countershaft 26, causing the first countershaft 26 to rotate in the second rotary direction R. Because the gear 52 is engaged with the first countershaft 26 by the synchronizer 44, the inner race 102 rotates in the second rotary direction R as well. However, movement of the inner race 102 in the direction R is restrained by the hill-holder assembly 90. Specifically, the inner race 102 is fixed for common rotation with the outer race 100 in the second rotary direction R. The outer teeth 124 of the outer race 100 releaseably engage with the first angled portion 130 of the hill-hold pawl 94, thereby substantially preventing rotation of both the inner race 102 and the outer race 100 in the second rotary direction R. Because the inner race 102 is splined to the gear 52, and the gear 52 is connected to the first countershaft 26 by the synchronizer 44 in the first gear ratio, rotation of the first countershaft 26 in the second rotary direction R is also substantially prevented. The transfer gear 84 of the first countershaft 26 meshes with the transfer gear 82 of the output shaft 14, thereby substantially preventing backwards rotation of the output shaft 14.

Referring now to FIG. 2A, the first angled portion 130 of the hill-hold pawl 94 remains engaged with the outer teeth 124 of the outer race 100 when the vehicle is on an incline. That is, the first engagement surface 133 of the hill-hold pawl 94 is dimensioned at about twelve degrees when measured from the first side 134 of the hill-hold pawl 94. However, it is understood that other dimensions may be used as well. The first engagement surface 133 is angled such that the hill-hold pawl 94 is engaged with the outer teeth 124 of the outer race 100 as the predefined load is exerted on the hill-hold pawl 94 through the outer race 100. The predefined load is the load exerted by the outer race 100 on the hill-hold pawl 94 when the vehicle is on an incline, where the vehicle can weigh up to the gross vehicle weight (GVW). The first engagement surface 133 of the hill-hold pawl 94 remains engaged with the outer teeth 124 when the vehicle is situated on an incline. However, the first engagement surface 133 of the hill-hold pawl 94 may disengage with the outer teeth 124 of the outer race 100 if the rod 140 is actuated accordingly. For example, the rod 140 can be actuated when the transmission 10 is shifted into the reverse gear ratio to disengage the hill-hold pawl 94 with the outer race 100.

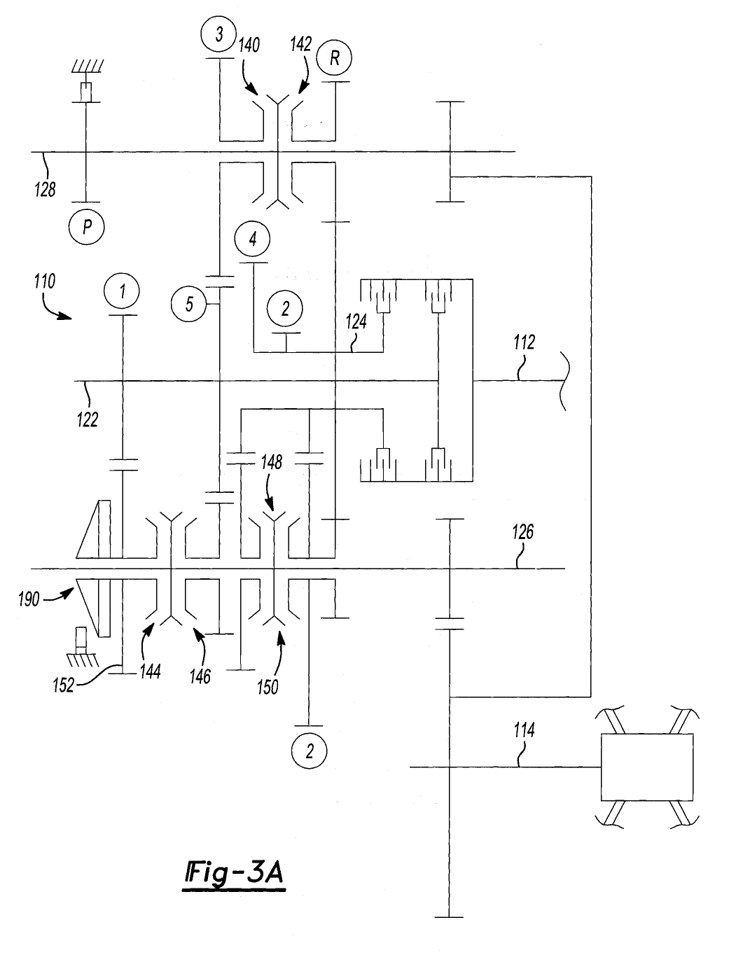

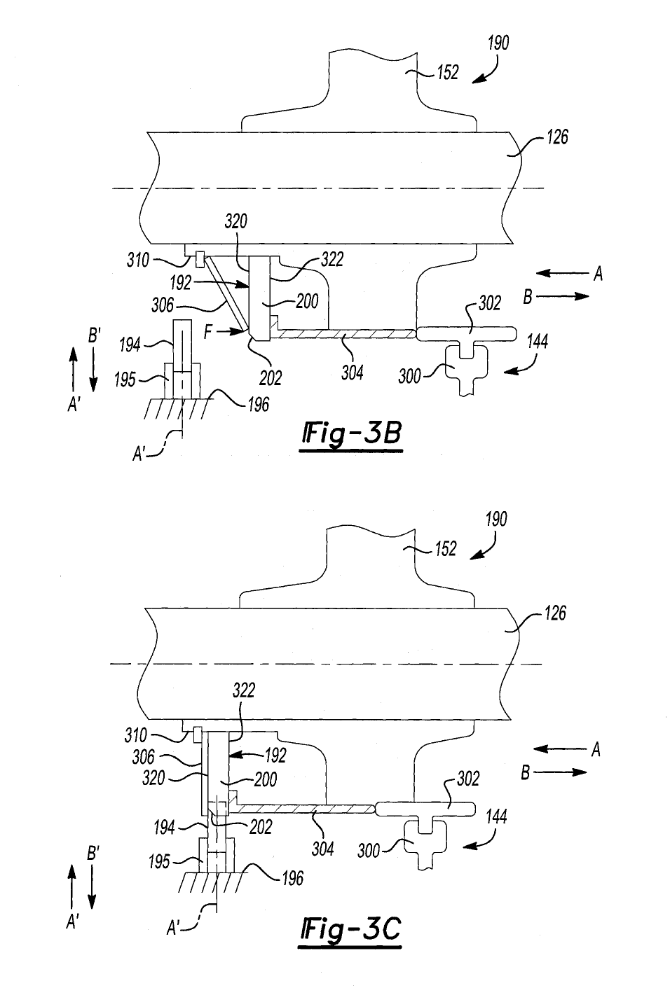

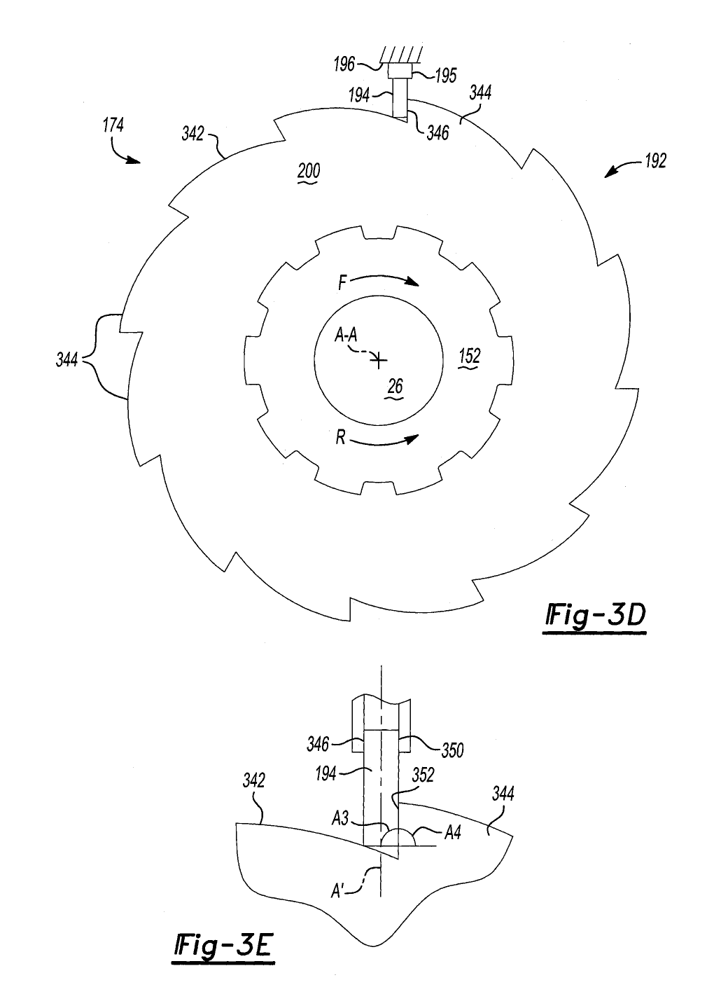

FIG. 3A is a schematic illustration of an alternative embodiment of a hill-holder assembly 190 that is activated as a transmission 110 is placed in the first gear ratio. In the embodiment as shown in FIG. 3A, the transmission 110 includes a similar gear arrangement as the transmission 10 illustrated in FIG. 1, and includes an input shaft 112, an output shaft 114, a first interconnecting member 122, a second interconnecting member 124, and countershafts 126 and 128. The transmission 110 also includes gear sets 1, 2, 3, 4, and 5 for creating a plurality of forward gears as well as a gear set R for creating a reverse gear. The transmission 110 also includes a plurality of synchronizers 140, 142, 144, 146, 148 and 150. Referring to FIGS. 3A-3C, the hill-holder assembly 190 is activated upon engagement of the synchronizer 144 with a gear 152 located along the first countershaft 126. Referring now to FIGS. 3B-3C, the synchronizer 144 includes a synchronizer fork 300, a collar 302, a apply ring 304, and a biasing member or spring 306. The hill-holder assembly 190 includes a hill-hold pin 194 that is attached to a portion of the transmission wall 196 by a bushing or bearing 195, as well as a clutch member 192. In the embodiment as shown, the hill-hold pin 194 is generally cylindrical and is rotateable about an axis A′-A′, however it is understood that the hill-hold pin 194 may have different geometrical configurations as well. The hill-hold pin 194 can also move in the directions A′ and B′ to selectively slide into and out of the bearing 195. The clutch member 192 includes a disk 200. The clutch member is slidably located within the gear 152, where the disk 200 of the clutch member 192 is splined to an outer surface 310 of the gear 152. The clutch member 192 has a first end face 320 and a second end face 322, where the spring 306 contacts the first end face 320 and the apply ring 304 contacts the second end face 322. The first end face 320 has a chamfered edge 202 that is used to facilitate engagement between the disk 200 and the hill-hold pin 194. The apply ring 304 axially moves the clutch member 192 in a first direction A and into an engaged position when the synchronizer 144 is engaged. The biasing member 306 axially moves the clutch member 192 in a second direction B and into a disengaged position when the synchronizer 144 is disengaged.

Referring now to FIG. 3B, the disk 200 of the clutch member 192 is not engaged with the hill-hold pin 194 in the disengaged position. The transmission 110 is not operating in the first gear ratio, and the synchronizer 144 is not engaged with the gear 152. The spring 306 exerts a biasing force F in the second direction B against the first end face 320 of the clutch member 192 to retain the clutch member 192 in the disengaged position. When the transmission 110 is shifted into the first gear ratio, the synchronizer fork 300 is moved in the first direction A towards the hill-hold pin 194. The synchronizer fork 300 is connected to a collar 302. Specifically, the synchronizer fork 300 receives a portion 330 of the collar 302, and the apply ring 304 is connected to the collar 302. Therefore, movement of the synchronizer fork 300 in the first direction A causes the apply ring 304 to also move in the first direction A. Because the apply ring 304 contacts the second end face 322 of the clutch member 192, the clutch 192 is also axially moved in the first direction A. The force exerted by the movement of the synchronizer fork 300 is sufficient to overcome the biasing force F exerted by the spring 306, and thus the clutch member 192 is axially moved into the second engaged position shown in FIG. 3C. The chamfered edge 202 of the disk 200 facilitates engagement between the disk 200 and the hill-hold pin 194 as the disk 200 is moved in the direction A towards the hill-hold pin 194. Specifically, the hill-hold pin 194 catches on and subsequently engages with one of the plurality of outer teeth 344 of the disk 200 (shown in FIG. 3D).

Although FIGS. 3A-3B illustrate the synchronizer 144 actuating the clutch member 192 back and forth between the engaged and disengaged positions, it is understood that the clutch member 192 could also be actuated by another separate synchronizer as well. For example, in another embodiment, an additional synchronizer could be added along the countershaft 126, where engagement of the additional synchronizer would actuate the clutch member 192 back and forth in the first and second directions A and B between the engaged and disengaged positions. Therefore, in this alternative embodiment, the engagement of the clutch member 192 with the hill hold pin 194 does not necessarily depend on the engagement of the transmission 110 into the first gear ratio. Instead, the clutch member 192 could engage with the hill-hold pin 194 when the transmission 110 is first gear ratio or in a neutral gear ratio. Moreover, the clutch member 192 could also be disengaged with the hill-hold pin 194 when the transmission 110 is in the first gear ratio as well.

FIG. 3C illustrates the clutch member 192 in the second engaged position where the disk 200 is engaged with the hill-hold pin 194. The disk 200 is engaged with the hill-hold pin 194 when the transmission 110 is engaged in the first gear ratio and the synchronizer 144 is engaged. The hill-hold pin 194 is also urged in the direction B′ and into the bearing 195 as the chamfered edge 202 of the disk 200 makes contact with and engages with the hill-hold pin 194. In the embodiment as shown, when the transmission 110 shifts out of the first gear ratio, the synchronizer 144 is disengaged, and the biasing force F (shown in FIG. 3B) exerted by the spring 306 will cause the clutch member 192 to axially move back into the disengaged position illustrated in FIG. 3A. When the synchronizer 144 is disengaged, the disk 200 no longer engages with the hill-hold pin 194, and the hill-hold pin 194 may move out of the bearing 195 in the direction A′.

FIG. 3D is a cross-sectioned view of the clutch member 192 and the hill-hold pin 194 held by the bearing 195 located on a portion of the transmission wall 196. FIG. 3D illustrates the clutch member 192 in the engaged position shown in FIG. 3C. In the embodiment as shown, the gear 152 is received by the disk 200 by a splined connection, however it is understood that other approaches may be used as well. The disk 200 is rotatable in the first rotary direction F and the second rotary direction R. The disk 200 has an outer surface 342 including the plurality of outer teeth 344. The outer teeth 344 of the disk 200 have a saw toothed profile configured to fixedly engage with the hill-hold pin 194. Specifically, the hill-hold pin 194 includes an outer surface 346 that fixedly engages with the outer teeth 344 of the disk 200. Specifically, as shown in FIG. 3E, the cylindrical outer surface 346 of the hill-hold pin 194 has a pin angle A3 measured with respect to a side surface 350 of the hill-hold pin 194. The outer teeth 344 also include an engagement surface 352 that is configured to engage with the side surface 350 of the hill-hold pin 194. In the embodiment as shown, the engagement surface 352 of the outer teeth 344 also include an engagement angle A4, where the pin angle A3 and the engagement angle A4 generally correspond to one another. In the embodiment as shown in FIGS. 3D-3E, both the pin angle A3 and the engagement angle A4 include a dimension of approximately ninety degrees. However, it is understood that other dimensions may be used as well. It should be noted that the rotation of the hill-hold pin 194 about the axis A′-A′ will not affect the movement of the disk 200. When the transmission 110 is engaged in the first gear ratio, the synchronizer 144 will engage the clutch member 192 with the hill-hold pin 194 such that the disk 200 is only able to rotate in the first rotary direction F. The engagement of the hill-hold pin 194 with the disk 200 substantially prevents the gear 152 and the first countershaft 26 from rotating in the reverse direction R when the vehicle (not shown) is positioned on an incline. When the transmission 110 is shifted out of the first gear ratio and into another gear ratio, such as the reverse gear ratio, the synchronizer 144 disengages and the biasing member 306 axially moves the clutch member 192 into the disengaged position. In this disengaged position, the hill-hold pin 194 does not engage with the disk 200, and the first countershaft 126 is able to rotate in the second rotary direction R.

The hill-holder assemblies 90 and 190 each substantially prevent rotation of the output shaft 14 in the reverse direction when the vehicle is positioned on an incline. The hill-holder assemblies 90 and 190 each provide a more cost-effective approach when compared to some other types of mechanisms that can be used as a hill-holder assembly. For example, the hill-holder assemblies 90 and 190 are typically less expensive and less complex than an electronic braking system.

The description of the invention is merely exemplary in nature and variations that do not depart from the gist of the invention are intended to be within the scope of the invention. Such variations are not to be regarded as a departure from the spirit and scope of the invention.

What is claimed is:

1. A device operable in a transmission of a vehicle for substantially preventing vehicular rollback on an incline, comprising:
a shaft rotatably supported in a transmission housing;
a gear selectively connected for common rotation with the shaft, wherein the gear is rotatable in a first rotary direction and a second rotary direction, wherein the first rotary direction represents a forward gear ratio of the transmission and the second rotary direction represents a reverse gear ratio of the transmission;
a one-way clutch having an inner race and an outer race, wherein the inner race is connected to the gear and the outer race has an outer surface having a plurality of engaging teeth, and wherein one-way clutch is configured to allow the inner race to rotate relative to the outer race when the gear rotates in the first rotary direction, and is configured to prevent the inner race from rotating relative to the outer race as the gear rotates in the second rotary direction; and
a pawl member having a first end and a second end where the first end is pivotly mounted to the transmission housing, and wherein the second end of the pawl has a first angled portion configured to releasably engage at least one of the plurality of engaging teeth of the outer race as the outer race rotates in the second rotary direction, where the first angled portion remains engaged with one of the plurality of engaging teeth under a predefined load, and
wherein the pawl includes a second angled portion configured to release from the plurality of engaging teeth of the outer race as the outer race rotates in the first direction.

2. The transmission of claim 1 wherein the first angled portion is angled at about twelve degrees when measured from a first side of the pawl.

3. The transmission of claim 1 wherein the second angled portion is angled at about forty-five degrees when measured from a second side of the pawl.

4. The transmission of claim 1 wherein the first angle and the second angle taper inwardly towards a center portion of the second end of the pawl.

5. The transmission of claim 1 wherein the predefined load is the load exerted by the outer race on the pawl when the vehicle is located on an incline.

6. The transmission of claim 1 wherein the pawl is actuated by a park pawl mechanism to selectively engage with the plurality of engaging teeth of the outer race.

7. The transmission of claim 1 wherein the one-way clutch is a sprag-clutch type assembly having a plurality of sprags that are located between the inner race and the outer race.

8. The transmission of claim 1 wherein the transmission is a dual-clutch type transmission.

9. The transmission of claim 1 wherein the inner race is connected to the first gear by a splined engagement.

10. The transmission of claim 1 wherein the gear is selectively connected to the shaft to achieve a first gear ratio.

11. A device operable in a transmission for substantially preventing vehicular rollback on an incline, comprising:
a shaft rotatably supported in a transmission housing;
a gear selectively connected for common rotation with the shaft, wherein the gear is rotatable in a first rotary direction and a second rotary direction, wherein the first rotary direction represents a forward gear ratio of the transmission and the second rotary direction represents a reverse gear ratio of the transmission;
a clutch member having a first end face, a second end face, and a disk, wherein the disk is coupled to the gear and has an outer surface having a plurality of engaging teeth;
a pin member having a first end and a second end, wherein the first end is coupled to the transmission housing, and wherein the second end of the pin fixedly engages with one of the plurality of engaging teeth of the outer surface of the clutch in an engaged position and disengages with the corresponding one of the plurality of engaging teeth in a disengaged position;
a biasing member in contact with the first end face of the clutch; and
a synchronizer assembly including a synchronizer fork and an apply ring, where the apply ring is axially moved by the synchronizer fork, and wherein the apply ring contacts the second end face of the clutch, and
wherein the apply ring is actuated in a first direction towards the pin to axially move the clutch into the engaged position when the forward gear ratio is selected, and the biasing member exerts a biasing force on the clutch in a second direction away from the pin to axially move the clutch into the disengaged position when the reverse gear ratio is selected.

12. The transmission of claim 11 wherein the pin includes an outer surface that is shaped to fixedly engage with the teeth of the disk as the disk rotates in the second direction.

13. The transmission of claim 12 wherein the outer profile of the pin is generally conical

14. The transmission of claim 13 wherein the teeth of the disk includes an engagement surface that generally corresponds to the outer profile of the pin.

15. The transmission of claim 11 wherein the synchronizer fork receives a collar, and wherein the collar is connected to the actuating member.

16. The transmission of claim 11 wherein the plurality of engaging teeth have a saw toothed profile.

17. The transmission of claim 11 wherein the transmission is a dual-clutch type transmission.

18. The transmission of claim 11 wherein the disk is coupled to the first gear by a splined engagement.

19. The transmission of claim 11 wherein the pin is coupled to the transmission housing by a bearing.

20. A device operable in a transmission for substantially preventing vehicular rollback on an incline, comprising:
a shaft rotatably supported in a transmission housing;
a gear selectively connected for common rotation with the shaft, wherein the gear is rotatable in a first rotary direction and a second rotary direction, wherein the first rotary direction represents a first gear ratio of the transmission and the second rotary direction represents a reverse gear ratio of the transmission;
a one-way clutch having an inner race and an outer race, wherein the inner race is connected to the gear and the outer race has an outer surface having a plurality of engaging teeth, and wherein one-way clutch is configured to allow the inner race to rotate relative to the outer race when the gear rotates in the first rotary direction, and is configured to prevent the inner race from rotating relative to the outer race as the gear rotates in the second rotary direction;
a pawl member having a first end and a second end where the first end is pivotly mounted to the transmission housing, and wherein the second end of the pawl has a first angled portion that is angled at about twelve degrees and configured to releasably engage at least one of the plurality of engaging teeth of the outer race as the outer race rotates in the second rotary direction, where the first angled portion remains engaged with one of the plurality of engaging teeth under a predefined load, and wherein the predefined load is the load exerted on the outer race when a vehicle is located on an incline; and
a parking pawl mechanism that actuates the pawl such that the pawl selectively engages with the plurality of engaging teeth of the outer race, and
wherein the pawl includes a second angled portion that is angled at about forty-five degrees and is configured to release from the plurality of engaging teeth of the outer race as the outer race rotates in the first direction.
